(19) United States
(12) Patent Application Publication
(10) Pub. No.: US 2008/0021998 A1
(43) Pub. Date: Jan. 24, 2008

(54) PRESENCE-BASED RESOURCE LOCATOR

(76) Inventor: Rachel Wentink, Indianapolis, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/458,876

(22) Filed: Jul. 20, 2006

(51) Int. Cl. G06F 15/173; G06F 15/16

(52) U.S. Cl. 709/226; 709/229

(57) ABSTRACT

Various technologies and techniques are disclosed for locating resources. A resource locator server is coupled to a call center server over a network. The system uses the resource locator server to allow users, such as call center agents, to access a list of resources available for answering a particular question and/or solving a particular problem. Users can access the resource locator server to search a ranked list of resources based on predefined levels of subject matter expertise and their desire to be contacted, and determine the availability of the resource through presence management. Resource profiles are created for each resource to specify desire to be contacted, expertise, and location. User profiles are created for each resource to specify permission levels for which resources can be contacted.

### BACKGROUND

Knowledge workers in call centers and other organizations often have a hard time determining who holds expertise in given areas. They must ask co-workers to track the experts down, in some cases asking multiple people before the right person is identified as a subject matter expert for the question at hand. The manual process slows down problem solving and reduces worker productivity. Other organizations have developed ways to track lists of experts. In fact, it can be done from a simple, static web page. The problem is that the data can change (expertise level) and the updates are not presented dynamically. The page doesn't show whether the user is immediately available, nor does it provide real-time access to contact them. Typically one may send an email, which does not provide quick response to questions or quick resolution of problems. Finally, it does not allow for a callback request to be parked on a user's queue to track whether the user picks it up. When an email is sent, the user often feels he has gone out into the void, unlike a parked interaction which can be monitored.

### SUMMARY

Various technologies and techniques are disclosed for locating resources. A call queue server receives incoming communications. A resource locator server is coupled to the call center server over a network. The system uses the resource locator server to allow users, such as call center agents, to access a list of resources available for answering a particular question and/or solving a particular problem. Users can access the resource locator server to search a ranked list of resources based on predefined levels of subject matter expertise and their desire to be contacted, and determine the availability of the resource through presence management. Resource profiles are created for each resource to specify desire to be contacted, expertise, and location. User profiles are created for each resource to specify permission levels for which resources can be contacted.

Yet other forms, embodiments, objects, advantages, benefits, features, and aspects of the present invention will become apparent from the detailed description and drawings contained herein.

### BRIEF DESCRIPTION OF THE DRAWINGS

FIG. 1 is a diagrammatic view of a computer system of one implementation.

FIG. 2 is a process flow diagram for the system of FIG. 1 demonstrating the stages involved in identifying and selecting a resource for solving a particular issue.

FIG. 3 is a process flow diagram for the system of FIG. 1 demonstrating the stages involved in selecting a resource from a frequently asked questions list.

FIG. 4 is a process flow diagram for the system of FIG. 1 demonstrating the stages involved in setting up resource and user profiles.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

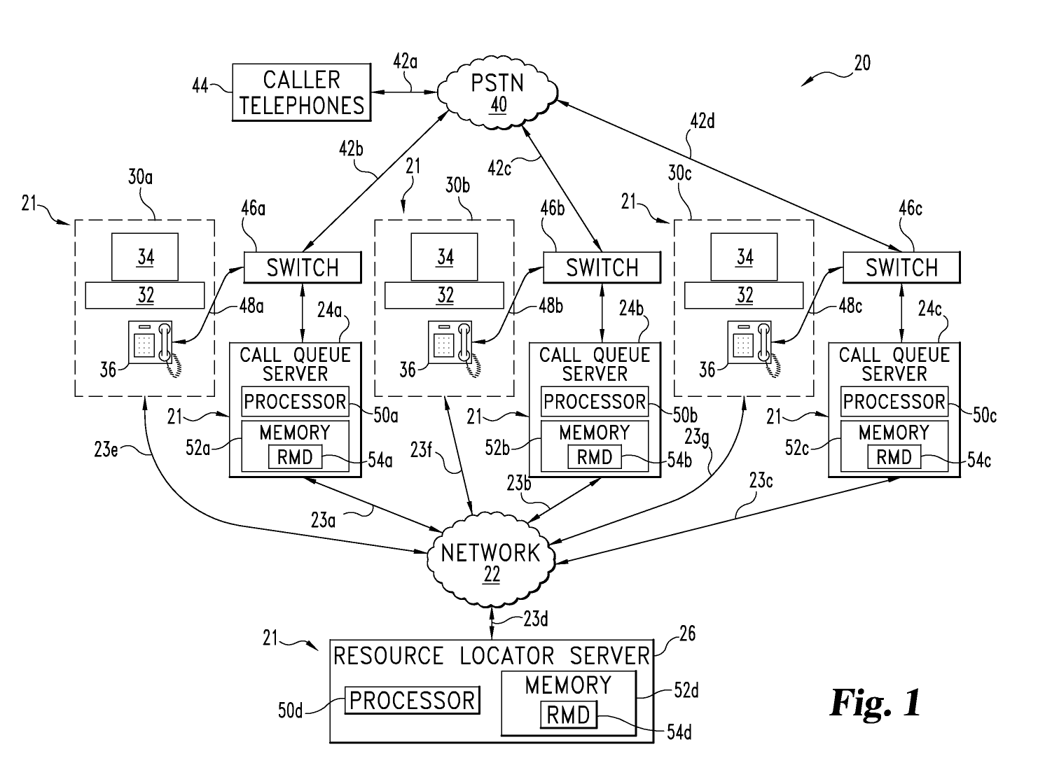

One implementation includes a unique system for locating resources for solving a particular issue, such as in a call center. FIG. 1 is a diagrammatic view of computer system 20 of one embodiment of the present invention. Computer system 20 includes computer network 22. Computer network 22 couples together a number of computers 21 over network pathways 23. More specifically, system 20 includes several servers, namely Call Queue Servers 24a, 24b, and 24c, and a Resource Locator Server 26. System 20 also includes agent client workstations 30a, 30b, and 30c. While computers 21 are each illustrated as being a server or client, it should be understood that any of computers 21 may be arranged to include both a client and server. Furthermore, it should be understood that while seven computers 21 are illustrated, more or fewer may be utilized in alternative embodiments.

Call Queue Servers 24a, 24b, and 24c and Resource Locator Server 26 include one or more processors or CPUs (50a, 50b, 50c, and 50d, respectively) and one or more types of memory (52a, 52b, 52c, and 52d, respectively). Each memory 52a, 52b, 52c, and 52d includes a removable memory device (54a, 54b, 54c, and 54d, respectively). Although not shown to preserve clarity, each computer 21 of system 20 includes one or more processors or CPUs and one or more types of memory. Each processor may be comprised of one or more components configured as a single unit. Alternatively, when of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement, such as one or more PENTIUM III or PENTIUM 4 processors supplied by INTEL Corporation of 2200 Mission College Boulevard, Santa Clara, Calif. 95052, USA.

Each memory (removable or generic) is one form of computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

System 20 further illustrates Public Switched Telephone Network (PSTN) 40 coupled to computer-controlled telephone switches 46a, 46b, and 46c (alternatively designated switches 46) of servers 24a, 24b, and 24c by pathways 42b, 42c, and 42d, respectively. Caller telephones 44 are coupled to PSTN 40 by pathway 42a. Switches 46 are also coupled to telephones 48a, 48b, and 48c (alternatively designated telephones 48). For the sake of clarity, each switch 46 is shown coupled to a corresponding telephone 48. However, is should be understood that each of telephones 48 may be coupled to one or more switches and that switches 48 may be located at one or more physical locations. Switches 46 may be arranged in the form of a Private Branch Exchange (PBX), predictive dialer, Automatic Call Distributor (ACD), a combination of these, or another switching configuration as would occur to those skilled in the art. Telephones 48 may be in the form of a handset, headset, or other arrangement as would occur to those skilled in the art. Telephones 48a, 48b, and 48c are each associated with a different one of agent workstations 30a, 30b, and 30c, respectively (collectively designated agent workstations 30). Agent workstations 30 each include an agent computer 32 coupled to a display 34. Agent computers 32 may be of the same type, or a heterogeneous combination of different computing devices. Likewise, displays 34 may be of the same type, or a heterogeneous combination of different visual devices. Although not shown to preserve clarity, each agent workstation 30 may also include one or more operator input devices such as a keyboard, mouse, track ball, light pen, and/or microtelecommunicator, to name just a few representative examples. Also, besides display 34, one or more other output devices may be included such as loudspeaker(s) and/or a printer.

Computer network 22 can be in the form of a Local Area Network (LAN), Municipal Area Network (MAN), Wide Area Network (WAN), such as the Internet, a combination of these, or such other network arrangement as would occur to those skilled in the art. The operating logic of system 20 can be embodied in signals transmitted over network 22, in programming instructions, dedicated hardware, or a combination of these. It should be understood that more or fewer computers 21 can be coupled together by computer network 22. It should also be recognized that computer network 22 may include one or more elements of PSTN 40. Indeed, in an alternate embodiment, PSTN 40 and computer network 22 are provided as a common network.

In one embodiment, system 20 operates as a call center at one or more physical locations that are remote from one another with call queue servers 24a, 24b, and 24c being configured as call center server hosts, Resource Locator Server 26 being configured as a server for identifying resources for handling a particular issue, and agent workstations 30a, 30b, and 30c each arranged as a call center client host. Additional telephones 48 may be connected to switches 46 that each correspond to an additional client host to provide more agent workstations 30 (not shown). Typically call center applications of system 20 would include many more agent workstations of this type at one or more physical locations, but only a few have been illustrated in FIG. 1 to preserve clarity. Also, one or more servers 24 may be configured as a call center server host at one or more physical locations.

Alternatively or additionally, system 20 may be arranged to provide for distribution and routing of a number of different forms of communication, such as telephone calls, voice mails, faxes, e-mail, web chats, web call backs, and the like. Furthermore, business/customer data associated with various communications may be selectively accessed with system 20. This data may be presented to an agent at each agent workstation 30 by way of monitor 34 operatively coupled to the corresponding agent computer 32.

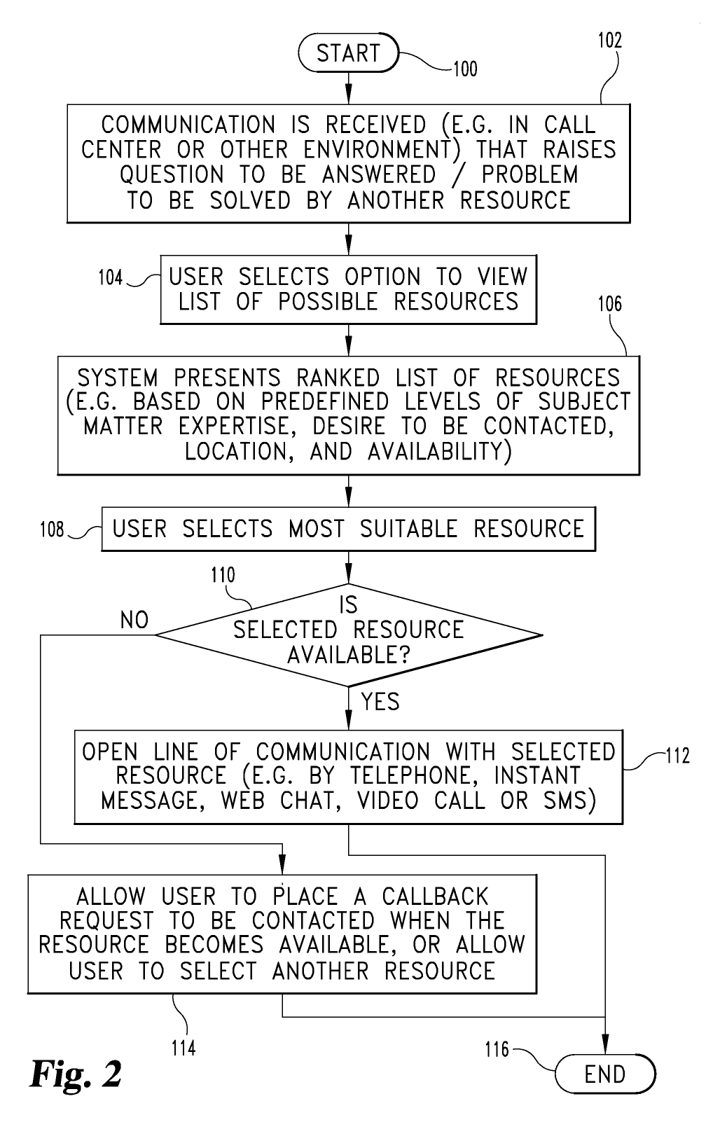

Turning now to FIGS. 2-4 with continued reference to FIGS. 1-2, the stages for implementing one or more aspects of system 20 are described in further detail. FIG. 2 is a high level process flow diagram that demonstrates a process for identifying and selecting a resource for resolving a particular issue. In one form, the process of FIG. 2 is at least partially implemented in the operating logic of system 20. The process begins at start point 100 with receiving a communication that raises a question to be answered or a problem to be solved by another resource other than the user who is handling the communication (stage 102). In one implementation, the communication is an incoming communication in a call center environment. The user selects an option to view a list of possible resources, such as experts, to help answer the question and/or solve the problem (stage 104). The system presents a ranked list of resources suitable for answering the question and/or solving the problem (stage 106). As one non-limiting example, the list of resources can be based on a pre-defined level of subject matter expertise, the desire of the resource to be contacted, location of the resource, and availability of the resource (stage 106).

The user reviews the list and selects the most appropriate resource (stage 108). If the selected resource is available (decision point 110), then a line of communication is opened with the selected resource (stage 112). As a few non-limiting examples, the selected resource can be contacted by telephone, instant message, web chat, video call, and/or SMS (stage 112). If the selected resource is not available (decision point 110), then the user can place a callback request to be contacted when the resource becomes available (stage 114). The process then ends at end point 110.

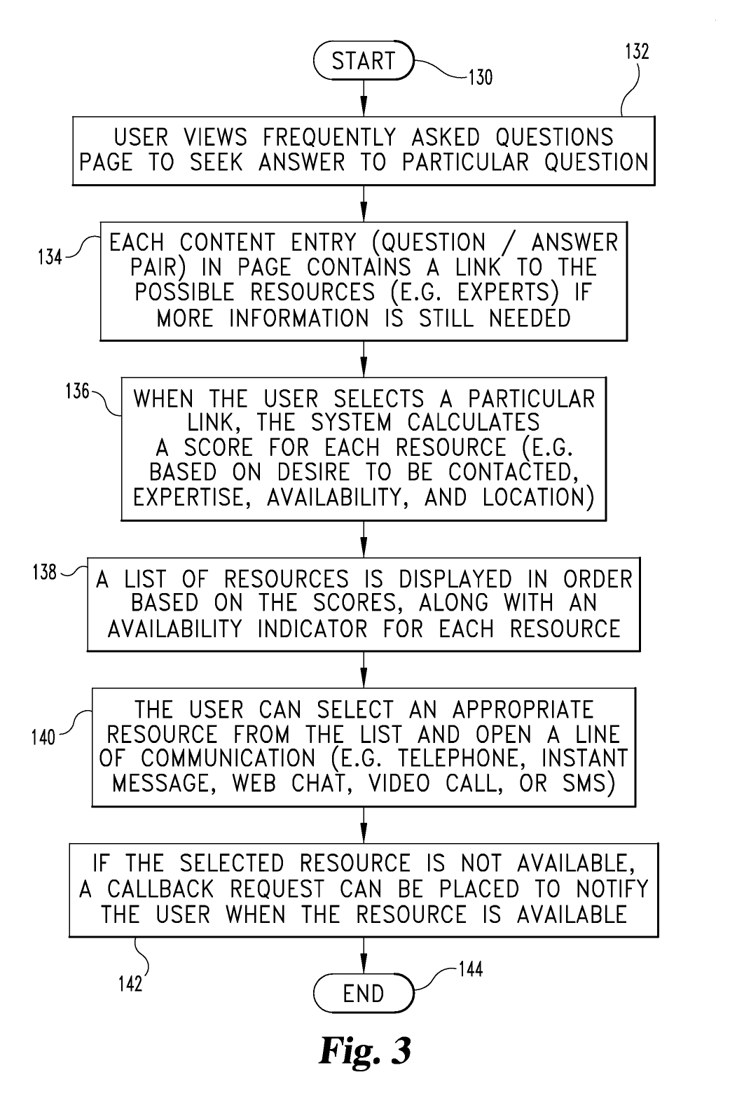

FIG. 3 illustrates the stages involved in selecting a suitable resource from a frequently asked questions list. In one form, the process of FIG. 3 is at least partially implemented in the operating logic of system 20. The process begins at start point 130 with the user viewing the frequently asked questions page to seek an answer to a particular question (stage 132). Each content entry (e.g. question and answer pair) in the FAQ page contains a link to the possible resource(s) to contact if more information is still needed (stage 134). When the user selects a particular link to see the possible resource(s), resource locator server 26 of system 20 calculates a score for each resource (stage 136). As one non-limiting example, the scores can be calculated based on the resource's desire to be contacted, expertise level, availability, and location (stage 136). A list of resources is then displayed in order based on the scores, along with an availability indicator for each resource (stage 138). The user can select an appropriate resource from the list and open a line of communication (stage 140). A few non-limiting examples of possible communication channels include telephone, instant message, web chat, video call, and/or SMS (stage 140). If the selected resource is not available, a callback request can be placed to notify the user when the resource is available (stage 142). The process then ends at end point 144.

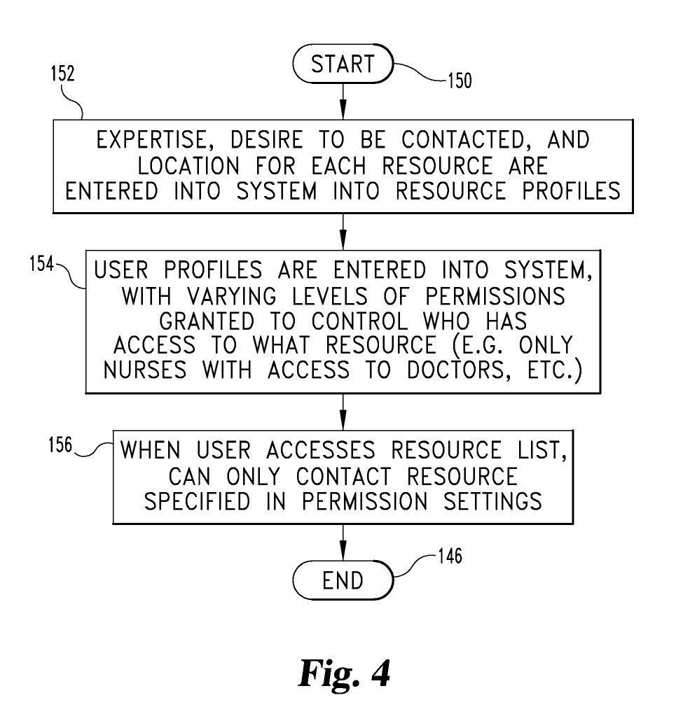

FIG. 4 illustrates the stages involved in setting up resource profiles and user profiles to be used by resource locator server 26. In one form, the process of FIG. 4 is at least partially implemented in the operating logic of system 20. The process begins at start point 150 with resource profiles being entered into resource locator server 26 (stage 152). Each resource profile includes information such as expertise, desire of the resource to be contacted, and location (stage 152). User profiles are entered into resource locator server 26 (stage 154). Each user profile includes information such as permissions settings that control which user has access to what resource (stage 154). As one non-limiting example, in a healthcare environment, nurses may have access to doctors and not researchers, and doctors may have access to researchers. Numerous other permissions levels are also possible. When a user accesses a resource list, he can only contact the resource(s) specified in the permission settings (stage 156). The process then ends at end point 158.

In one embodiment, a method is disclosed that comprises: receiving a communication that raises a question to be answered by another resource. A selection of an option to view a list of possible resources to help answer the question is received. A ranked list of resources suitable for answering the question is presented, with the ranked list being determined based upon an expertise level of each of a plurality of possible resources, a desire of each of the resources to be contacted, a location of each of the resources, and an availability of each of the resources.

In another embodiment, a computer-readable medium having computer-executable instructions is disclosed that comprises logic for: receiving a request from a user to view a frequently asked questions page. The frequently asked question page is displayed with a plurality of question and answer pairs, with each question and answer pair having a resource link to allow the user to identify a resource to contact for more information if needed. A selection is received from the user to select a particular one resource link. A score is calculated for each possible resource. An ordered list of possible resources is generated based upon the score.

In yet a further embodiment, a system is disclosed that comprises: at least one call center server, the call center server including means for queuing communications. A resource locator server is coupled to the call center server over a network. The resource locator server including means for receiving a selection of an option to view a list of possible resources to help answer a particular question raised during an incoming communication, and means for presenting a ranked list of resources suitable for answering the question. The resource locator server determines the ranked list of resources based upon an expertise level of each of a plurality of possible resources, a desire of each of the resources to be contacted, a location of each of the resources, and an availability of each of the resources.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

What is claimed is:

1. A method comprising:
receiving a communication that raises a question to be answered by another resource;
receiving a selection of an option to view a list of possible resources to help answer the question; and
presenting a ranked list of resources suitable for answering the question, wherein the ranked list is determined based upon an expertise level of each of a plurality of possible resources, a desire of each of the resources to be contacted, a location of each of the resources, and an availability of each of the resources.

2. The method of claim 1 further comprising:
receiving a selection to initiate a communication with a particular one of the possible resources.

3. The method of claim 2 further comprising:
opening a communication channel with the particular one of the possible resources.

4. The method of claim 3 further comprising:
setting a callback request with the particular one resource if the particular one resource is not available.

5. The method of claim 1, wherein the incoming communication is a voice call.

6. The method of claim 1, wherein the incoming communication is a web chat.

7. The method of claim 1, wherein the incoming communication is an instant message.

8. The method of claim 1, wherein the possible resources presented on the ranked list are determined at least in part by reviewing a permissions level specified in a profile associated with a user that selected the option to view the list.

9. A computer-readable medium having computer-executable instructions for causing a computer to perform the steps recited in claim 1.

10. A computer-readable medium having computer-executable instructions for causing a computer to perform steps comprising:
receiving a request from a user to view a frequently asked questions page;
displaying the frequently asked question page with a plurality of question and answer pairs, with each question and answer pair having a resource link to allow the user to identify a resource to contact for more information if needed;
receiving a selection from the user to select a particular one resource link;
calculating a score for each possible resource; and
generating an ordered list of possible resources based upon the score.

11. The computer readable medium of claim 1, wherein the score is calculated for each possible resource based at least in part upon a desire to be contacted, expertise, availability, and location.

12. The computer readable medium of claim 1, wherein the ordered list includes an availability indicator for each possible resource.

13. The computer readable medium of claim 1, wherein a particular one of the possible resources can be selected by the user to open a line of communication.

14. The computer readable medium of claim 13, wherein a callback request can be placed with the particular one of the possible resources if the particular one is not available when selected by the user.

15. A system comprising:
at least one call center server, the call center server including means for queuing communications;
a resource locator server coupled to the call center server over a network, the resource locator server including means for receiving a selection of an option to view a list of possible resources to help answer a particular question raised during an incoming communication, and means for presenting a ranked list of resources suitable for answering the question; and
wherein the resource locator server determines the ranked list of resources based upon an expertise level of each of a plurality of possible resources, a desire of each of the resources to be contacted, a location of each of the resources, and an availability of each of the resources.

16. The system of claim 15, further comprising:
means for receiving a selection from a user of a particular one resource on the ranked list of resources.

17. The system of claim 16, further comprising:
means for initiating a communication with the particular one resource.

18. The system of claim 17, further comprising:
means for setting a callback request with the particular one resource if the particular one resource is not available.
